(19) United States
(12) Patent Application Publication
(10) Pub. No.: US 2017/0280728 A1
(43) Pub. Date: Oct. 5, 2017

(54) ANTIMICROBIAL COMPOSITIONS AND METHODS OF THEIR USE

(71) Applicant: CMS TECHNOLOGY, INC.., New York, NY (US)

(72) Inventors: Francis DAUTREUIL, Seabrook, TX (US); Ron SHAPIRA, New York, NY (US); John MECCIA, Ringoes, NJ (US); Seth HYATT, Huntingdon Valley, PA (US)

(21) Appl. No.: 15/509,688

(22) PCT Filed: Sep. 11, 2015
(86) PCT No.: PCT/US2015/049580

§ 371 Date: Mar. 8, 2017

Related U.S. Application Data
(60) Provisional application No. 62/049,969, filed on Sep. 12, 2014.

(51) Int. Cl. A01N 59/20; A23L 3/358; A23B 7/154; A23L 3/3481; A01N 59/00; A23B 4/20

(52) U.S. Cl. CPC A01N 59/20; A01N 59/00; A23B 4/20; A23B 7/154; A23L 3/3481; A23L 3/358; A23V 2002/00

(57) ABSTRACT

The present disclosure is directed to antimicrobial compositions comprising a hypochlorite salt, a copper (II) salt, and an optionally acid that is an inorganic acid, an organic acid, or a combination thereof, and optionally a buffering agent, and having a chlorine concentration of between 0.1 ppm and 300 ppm and a copper (II) concentration of between 0.1 ppm and 300 ppm. Methods of making and using these compositions is also described.

### CROSS REFERENCE TO RELATED APPLICATIONS

This application claims the benefit of U.S. Provisional Application No. 62/049,969, filed Sep. 12, 2014, the entirety of which is incorporated herein by reference.

### TECHNICAL FIELD

The disclosure is directed to antimicrobial compositions comprising a hypochlorite salt, a copper (II) salt, and optionally an acid that is an inorganic acid, an organic acid, or a combination thereof, and having a chlorine concentration of 0.1 to 300 ppm and a copper (II) concentration of 0.1 to 300 ppm. Methods of making and using these compositions are also described.

### BACKGROUND

Contamination of surfaces by toxic levels of bacteria and viruses is a significant concern. Antimicrobial compositions used in the food industry must not only be capable of reducing the number of surface microbes, they must be safe for human consumption. In addition, antimicrobial compositions should not detrimentally affect the quality of the foodstuff being treated. Antimicrobial compositions for use on foodstuffs should also be easy to apply and relatively inexpensive. New antimicrobial compositions that are safe, effective, easy to apply, and economical are needed.

### SUMMARY

The present disclosure is directed to compositions comprising a hypochlorite salt, a copper (II) salt, and optionally an acid that is an inorganic acid, an organic acid, or a combination thereof; and optionally a buffering agent, wherein the composition has a chlorine concentration of 0.1 to 300 ppm and a copper (II) concentration of 0.1 to 300 ppm. Methods of making these compositions is described. Methods of using these compositions in antimicrobial applications are also described.

### DETAILED DESCRIPTION OF ILLUSTRATIVE EMBODIMENTS

The following description of the preferred embodiments is merely exemplary in nature and is in no way intended to limit the invention, its application, or uses.

As used throughout, ranges are used as shorthand for describing each and every value that is within the range. Any value within the range can be selected as the terminus of the range.

It has now been determined that compositions comprising a hypochlorite, copper (II) salt, and optionally an acid, having a chlorine concentration of 0.1 to 300 ppm and a copper (II) concentration of 0.1 to 300 ppm, are effective in reducing the number of microbes on surfaces, for example hard surfaces and foodstuff surfaces. In some embodiments, these compositions may further include a buffering agent.

Bleach, for example sodium hypochlorite and calcium hypochlorite, is a known antimicrobial agent. But bleach can be damaging to foodstuffs and hard surfaces at high concentrations. Bleach also has an aversive smell at higher concentrations, which is undesirable in the food industry. Additionally, exposure to higher concentrations of bleach can have detrimental health effects. Moreover, in order to maintain “organic” certification, foodstuffs must have minimal residual chlorine. Copper (II) salts have very little, if any, effect on antimicrobial activity at low concentrations. Nevertheless, the combination of hypochlorite salt, copper (II) salt, and optionally an acid (inorganic acid, organic acid, or a combination thereof), and optionally a buffering agent, wherein the combination has a chlorine concentration of between 0.1 ppm and 300 ppm and a copper (II) concentration of between 0.1 ppm and 300 ppm, results in compositions having antimicrobial activity that is significantly greater than hypochlorite, copper (II) salts, or acid, alone.

As used herein, “foodstuffs” refers to solid food products that are edible by humans or domesticated animals. Solid food products include meat product such as poultry products (chicken, duck, and turkey products), eggs, beef products, pork products, and seafood products (fish and shellfish). Solid food products also include produce products, for example, fruits, vegetables, seeds, grains, sprouts, legumes, soy, and nuts. Solid food products also include dairy products such as hard, soft, and semi-soft cheeses.

As used herein, “hard surfaces” refers to wood, ceramic tile, concrete, porcelain tile, linoleum, laminates, composite materials, stainless steel, plastic, and the like.

As used herein, “microbes” include bacteria and viruses. Examples of bacteria that can be reduced using the compositions of the disclosure include gram positive bacteria and gram negative bacteria, for example, salmonella enteritidis, listeria monocytogenes, Escherichia coli, clostridium botulinum, campylobacter, and combinations thereof Examples of viruses that can be reduced using the compositions of the disclosure include enterovirus, norovirus, influenza, rotavirus, and combinations thereof.

The compositions of the disclosure may include hypochlorite as a hypochlorite salt, as a chlorine source. Hypochlorite salts include sodium hypochlorite, calcium hypochlorite, magnesium hypochlorite, and combinations thereof A preferred hypochlorite salt is sodium hypochlorite.

The hypochlorite salts of the disclosure can be present in amounts ranging from about 0.1 ppm to about 300 ppm. The hypochlorite salt can be present in the compositions of the disclosure in concentrations of from 0.1 ppm to 275 ppm, 0.1 ppm to 250 ppm, 0.1 ppm to 225 ppm, 0.1 ppm to 200 ppm, 0.1 ppm to 175 ppm, 0.1 ppm to 150 ppm, 0.1 ppm to 125 ppm, 0.1 ppm to 100 ppm, 0.1 ppm to 75 ppm, 0.1 ppm to 50 ppm, 0.1 ppm to 25 ppm, 0.1 ppm to 10 ppm, 0.1 ppm to 4 ppm or 0.1 ppm to 5 ppm. Other preferred compositions of the disclosure include about 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 110, 120, 130, 140, 150, 160, 170, 180, 190, 200, 210, 220, 230, 240, 250, 260, 270, 280, 290, or about 300 ppm of the hypochlorite salt. The amount of hyochlorite in a composition of the disclosure can be calculated on a mass basis.

The compositions of the disclosure have a chlorine, also referred to in the art as “free chlorine,” concentration of between 0.1 ppm and 300 ppm. Those skilled in the art can determine chlorine concentrations of aqueous solutions comprising compositions of the disclosure using methods known in the art, for example, spectrophotometric or ampherometric methods. According to the disclosure, chloride concentration can be calculated on a mass basis. Confirmation of chlorine concentration in a composition of the disclosure can be determined with a Hach DR/890 Colorimeter utilizing the corresponding AccuVac® Ampules for Free Available Chlorine (FAC). The chlorine concentration can be present in amounts ranging from about 0.1 ppm to about 300 ppm. In other embodiments, the chlorine concentration can be present in amounts of from 0.1 ppm to 275 ppm, 0.1 ppm to 250 ppm, 0.1 ppm to 225 ppm, 0.1 ppm to 200 ppm, 0.1 ppm to 175 ppm, 0.1 ppm to 150 ppm, 0.1 ppm to 125 ppm, 0.1 ppm to 100 ppm, 0.1 ppm to 75 ppm, 0.1 ppm to 50 ppm, 0.1 ppm to 25 ppm, 0.1 ppm to 10 ppm, 0.1 ppm to 4 ppm or 0.1 ppm to 5 ppm. Other preferred compositions of the disclosure have a chlorine concentration of about 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 110, 120, 130, 140, 150, 160, 170, 180, 190, 200, 210, 220, 230, 240, 250, 260, 270, 280, 290, or about 300 ppm.

The compositions of the disclosure also include a copper (II) salt. Preferred copper (II) salts include copper (II) sulfate, copper (II) chloride, copper (II) bromide, and the like, as well as combinations thereof. A preferred copper (II) salt is copper (II) sulfate.

The compositions of the disclosure comprise between about 0.1 ppm and about 1200 ppm of the copper (II) salt. The copper (II) salt is present in the compositions of the disclosure in concentrations of 0.1 pm to 1000 ppm, 0.1 ppm to 750 ppm, 0.1 ppm to 500 ppm, 0.1 ppm to 275 ppm, 0.1 ppm to 250 ppm, 0.1 ppm to 225 ppm, 0.1 ppm to 200 ppm, 0.1 ppm to 175 ppm, 0.1 ppm to 150 ppm, 0.1 ppm to 125 ppm, 0.1 ppm to 100 ppm, 0.1 ppm to 75 ppm, 0.1 ppm to 50 ppm, 0.1 ppm to 25 ppm, 0.1 ppm to 10 ppm, or 0.1 ppm to 5 ppm. Other preferred compositions of the disclosure include about 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 11, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 210, 220, 230, 240, 250, 260, 270, 280, 290, 300, 400, 500, 600, 700, 800, 900, 1000, 1100, or about 1200 ppm of the copper (II) salt. The amount of copper (II) salt present in a composition of the disclosure can be determined on a mass basis.

The compositions of the disclosure have a copper (II) concentration of between 0.1 and 300 ppm. Those skilled in the art can determine copper (II) concentrations of aqueous solutions comprising compositions of the disclosure using methods known in the art, for example, spectrophotometric methods. The copper (II) concentration can be present in amounts ranging from about 0.1 ppm to about 300 ppm. Alternatively, the copper (II) concentration in compositions of the disclosure is 0.1 ppm to 275 ppm, 0.1 ppm to 250 ppm, 0.1 ppm to 225 ppm, 0.1 ppm to 200 ppm, 0.1 ppm to 175 ppm, 0.1 ppm to 150 ppm, 0.1 ppm to 125 ppm, 0.1 ppm to 100 ppm, 0.1 ppm to 75 ppm, 0.1 ppm to 50 ppm, 0.1 ppm to 25 ppm, 0.1 ppm to 10 ppm, or 0.1 ppm to 5 ppm. Other preferred compositions of the disclosure include a copper (II) concentration of about 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 11, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 210, 220, 230, 240, 250, 260, 270, 280, 290, or about 300 ppm. The amount of copper (II) in a composition of the disclosure can be determined with a Hach DR/890 Colorimeter utilizing the corresponding AccuVac® Ampules for Copper.

The compositions of the disclosure optionally include an acid that is an inorganic acid, an organic acid, or a combination thereof Exemplary acids include, for example, ascorbic acid, citric acid, lactic acid, lauric acid, hydrochloric acid, phosphoric acid, sulfuric acid, and the like, as well as combinations thereof Preferred acids include sulfuric acid, lactic acid, citric acid, and combinations thereof The acid, when present, can be present in any amount so as to achieve a predetermined pH, as described herein.

In some embodiments of the disclosure, the compositions may further include a buffering agent, that is, a compound that controls the pH of the compositions to within a pre-selected range. Buffering agents are known in the art, per se, and include, for example, conjugate salts of acids. Preferred buffering agents include sulfate salts, for example, ammonium sulfate, calcium sulfate, and sodium sulfate, and combinations thereof. The buffering agent may be present in an amount of from about 0.1 to about 1.0 weight percent, based on the weight of the compositions. For example, the buffering agent may be present at about 0.1, 0.2, 0.3, 0.4, 0.5, 0.6, 0.7, 0.8, 0.9, or about 1.0 percent, based on the weight of the composition.

Some compositions of the disclosure consist essentially of the hypochlorite salt, the copper (II) salt, and the acid, with the chlorine and copper (II) concentrations as described herein. That is, the disclosure envisions compositions that include the hypochlorite salt, the copper (II) salt, the acid, and the chlorine and copper (II) concentrations as described herein, and only those additional materials that do not materially affect the basic and novel characteristics of the inventions disclosed herein. Other compositions of the disclosure consist essentially of the hypochlorite salt, the copper (II) salt, the acid, and the buffering agent, with the chlorine and copper (II) concentrations as described herein. That is, the disclosure envisions compositions that include the hypochlorite salt, the copper (II) salt, the acid, the buffering agent, and the chlorine and copper (II) concentrations as described herein, and only those additional materials that do not materially affect the basic and novel characteristics of the inventions disclosed herein.

Some compositions of the disclosure consist essentially of the hypochlorite salt and the copper (II) salt, with the chlorine and copper (II) concentrations as described herein. That is, the disclosure envisions compositions that include the hypochlorite salt and the copper (II) salt, and the chlorine and copper (II) concentrations as described herein, and only those additional materials that do not materially affect the basic and novel characteristics of the inventions disclosed herein.

Some compositions of the disclosure consist essentially of water, the hypochlorite salt, the copper (II) salt, and the acid, with the chlorine and copper (II) concentrations as described herein. That is, the disclosure envisions compositions that include water, the hypochlorite salt, the copper (II) salt, the acid, the chlorine and copper (II) concentrations as described herein and only those additional materials that do not materially affect the basic and novel characteristics of the inventions disclosed herein. Some compositions of the disclosure consist essentially of water, the hypochlorite salt, the copper (II) salt, the acid, and the buffering agent, with the chlorine and copper (II) concentrations as described herein. That is, the disclosure envisions compositions that include water, the hypochlorite salt, the copper (II) salt, the acid, the buffering agent, the chlorine and copper (II) concentrations as described herein and only those additional materials that do not materially affect the basic and novel characteristics of the inventions disclosed herein.

Some compositions of the disclosure consist essentially of water, the hypochlorite salt, and the copper (II) salt, with the chlorine and copper (II) concentrations as described herein. That is, the disclosure envisions compositions that include water, the hypochlorite salt, and the copper (II) salt, the chlorine and copper (II) concentrations as described herein and only those additional materials that do not materially affect the basic and novel characteristics of the inventions disclosed herein.

The aqueous solutions of the disclosure can have a neutral pH (about pH 7) or acidic pH (pH less than 7) or slightly alkaline pH (pH up to about 9). In preferred embodiments, the pH is between about 1 and 7. In some embodiments, the pH is between about 2 and 7. In other embodiments, the pH is between about 3 and 7. In still other embodiments, the pH is between about 4 and 7. Preferably, the pH of the aqueous solutions of the disclosure is about 1, 1.5, 2, 2.5, 3, 3.5, 4, 4.5, 5, 5.5, 6, 6.5, 7,7.5, 8,8.5, or about 9. According to the disclosure, the pH of the aqueous solutions is tested at about 25° C., unless otherwise noted, using methods known in the art. Those skilled in the art readily appreciate that the pH of the aqueous solutions of the disclosure can be adjusted by adjusting the amount of the acid and/or base in the solution.

In other embodiments, the compositions are solid compositions comprising the hypochlorite salt, the copper (II) salt, and optionally the acid and optionally the buffering agent, in the amounts recited herein. These solid compositions comprise 10% or less, by weight, of water/moisture. Examples are such solid compositions include pellets, granules, powders, and tablets. These solid compositions can include chlorine and copper (II) in the concentrations recited herein. Alternatively, the solid compositions can be used to prepare other compositions that include chlorine and copper (II) in the concentrations recited herein.

In still other embodiments, the compositions are solid compositions are encased in a water-soluble film, for example, a polyvinyl alcohol film, an aliphatic polyether film, or a polyethylene glycol film. Such films are known in the art. Suitable films will be completely soluble or dispersible in water at temperatures above about 5° C. The films will have a thickness of about 0.5 mls to about 5 mls, preferably from about 1 to 3 mls. The water-soluble films can be sealed using, for example, heat or ultrasonic sealing methods known in the art.

Other embodiments of the disclosure include methods comprising adding a copper (II) salt and optionally an acid that is an inorganic acid, an organic acid, or a combination thereof, to a first aqueous solution comprising a hypochlorite salt, and producing a second aqueous solution comprising the hypochlorite salt, the copper (II) salt, and the optional acid. The first aqueous solution may also optionally comprise a buffering agent. The second aqueous solution will have a pH below 7, a chlorine concentration of between 0.1 ppm and 300 ppm, and a copper (II) concentration of between 0.1 ppm and 300 ppm. According to these methods, the second aqueous solution contacts a surface. Preferably, the second aqueous solution is applied to the surface. Alternatively, the first aqueous solution can be applied to a surface, followed by application of the copper (II) salt and the optional acid to the surface. The surface can be any of the hard surfaces or foodstuff surfaces described herein. Using these methods, microbial reduction on the surface can be achieved.

The hypochlorite salt can be present in the first aqueous solutions of the disclosure in amounts of from 0.1 ppm to 275 ppm, 0.1 ppm to 250 ppm, 0.1 ppm to 225 ppm, 0.1 ppm to 200 ppm, 0.1 ppm to 175 ppm, 0.1 ppm to 150 ppm, 0.1 ppm to 125 ppm, 0.1 ppm to 100 ppm, 0.1 ppm to 75 ppm, 0.1 ppm to 50 ppm, 0.1 ppm to 25 ppm, 0.1 ppm to 10 ppm, 0.1 ppm to 4 ppm or 0.1 ppm to 5 ppm. Other preferred first aqueous solutions of the disclosure include about 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 110, 120, 130, 140, 150, 160, 170, 180, 190, 200, 210, 220, 230, 240, 250, 260, 270, 280, 290, or about 300 ppm of the hypochlorite salt.

A preferred hypochlorite salt is sodium hypochlorite or calcium hypochlorite with sodium hypochlorite being particularly preferred.

In preferred embodiments, the first aqueous solution has a pH of less than 7.

Preferably about 0.1 ppm and about 1200 ppm of the copper (II) salt is added to the first aqueous solution. Alternatively 0.1 ppm to 1000 ppm, 0.1 ppm to 750 ppm, 0.1 ppm to 500 ppm, 0.1 ppm to 275 ppm, 0.1 ppm to 250 ppm, 0.1 ppm to 225 ppm, 0.1 ppm to 200 ppm, 0.1 ppm to 175 ppm, 0.1 ppm to 150 ppm, 0.1 ppm to 125 ppm, 0.1 ppm to 100 ppm, 0.1 ppm to 75 ppm, 0.1 ppm to 50 ppm, 0.1 ppm to 25 ppm, 0.1 ppm to 10 ppm, or 0.1 ppm to 5 ppm of the copper (II) salt is added to the first aqueous solution. In other embodiments, 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 11, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 210, 220, 230, 240, 250, 260, 270, 280, 290, 300, 400, 500, 600, 700, 800, 900,1000, 1100, or about 1200 ppm of the copper (II) salt is added to the first aqueous solution.

Preferred copper (II) salts include copper (II) sulfate, copper (II) chloride, copper (II) bromide, and the like. A preferred copper (II) salt is copper (II) sulfate.

An acid that is an inorganic acid, an organic acid, or a combination thereof is optionally added to the first aqueous solution. Exemplary acids include, for example, ascorbic acid, citric acid, lactic acid, lauric acid, hydrochloric acid, phosphoric acid, sulfuric acid, and the like, as well as combinations thereof Preferred acids include sulfuric acid, lactic acid, citric acid, and combinations thereof The amount of acid, when used, will be the amount necessary to achieve a predetermined pH, as described herein.

In some embodiments, the copper (II) salt and the optional acid are added to the first aqueous solution as a third aqueous solution comprising the copper (II) salt and the optional acid.

In preferred embodiments, the second aqueous solution has a pH of less than 7. For example, the second aqueous solution has a pH of between 1 and 6.9, 2 and 6.9, 3 and 6.9, 4 and 6.9, or between 5 and 6.9. Preferred pH of the second aqueous solution is 0.5, 1, 1.5, 2, 2.5, 3, 3.5, 4, 4.5, 5, 5.5, 6, or 6.5, when tested at about 25° C.

The second aqueous solutions of the disclosure have a chlorine concentration of between 0.1 and 300 ppm. The chlorine concentration can be present in amounts ranging from about 0.1 ppm to about 300 ppm. The chlorine concentration of the second aqueous solution can be from 0.1 ppm to 275 ppm, 0.1 ppm to 250 ppm, 0.1 ppm to 225 ppm, 0.1 ppm to 200 ppm, 0.1 ppm to 175 ppm, 0.1 ppm to 150 ppm, 0.1 ppm to 125 ppm, 0.1 ppm to 100 ppm, 0.1 ppm to 75 ppm, 0.1 ppm to 50 ppm, 0.1 ppm to 25 ppm, 0.1 ppm to 10 ppm, 0.1 ppm to 4 ppm or 0.1 ppm to 5 ppm. Other preferred embodiments of the disclosure have a chlorine concentration of about 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 110, 120, 130, 140, 150, 160, 170, 180, 190, 200, 210, 220, 230, 240, 250, 260, 270, 280, 290, or about 300 ppm.

The second aqueous solutions of the disclosure have a copper (II) concentration of between 0.1 and 300 ppm. The copper (II) concentration of the second aqueous solutions can be present in amounts ranging from about 0.1 ppm to about 300 ppm. The copper (II) concentration in the second aqueous solutions of the disclosure is 0.1 ppm to 275 ppm, 0.1 ppm to 250 ppm, 0.1 ppm to 225 ppm, 0.1 ppm to 200 ppm, 0.1 ppm to 175 ppm, 0.1 ppm to 150 ppm, 0.1 ppm to 125 ppm, 0.1 ppm to 100 ppm, 0.1 ppm to 75 ppm, 0.1 ppm to 50 ppm, 0.1 ppm to 25 ppm, 0.1 ppm to 10 ppm, or 0.1 ppm to 5 ppm. In other preferred embodiments, the second aqueous solutions of the disclosure have a copper (II) concentration of about 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 11, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 210, 220, 230, 240, 250, 260, 270, 280, 290, or about 300 ppm.

The compositions of the disclosure are effective in reducing the number of microbes on a surface. That is, treating surfaces with compositions of the disclosure reduces the growth and/or propagation of bacteria and/or viruses (for example, by killing the bacteria or virus) on the surface, as compared to a surface that has not been treated with a composition of the disclosure. For example, the compositions of the disclosure are effective in reducing the number of microbes by about 10%, as compared to a surface that has not been treated with a composition of the disclosure. In other embodiments, the compositions of the disclosure are about 20%, 30%, 40%, 50%, 60%, 70%, 80%, 90%, 100%, 110%, 120%, 130%, 140%, 150%, 160%, 170%, 180%, 190%, 200%, 300%, 400%, 500%, or greater, more effective in reducing microbes on a surface, when compared to a surface that has not been treated with a composition of the disclosure.

The surfaces can be treated via any means known in the art. For example, in preferred embodiments, any composition of the disclosure can be applied to the surfaces of the foodstuffs via sprinkling, spraying, rinsing, soaking, immersing, washing, and the like.

The methods of the invention achieve a reduction in microbial load within about 3 minutes of application. For example, a reduction in microbial load will be observed after the compositions of the disclosure have been applied to a surface after about 1 minute, about 2 minutes, or about three minutes. Reduction in microbial load will also be observed after longer time periods, for example, about 15 minutes, about 30 minutes, about 1 hour, about 1.5 hours, about 2 hours, about 2.5 hours, about 3 hours, or longer.

The following examples are provided to illustrate compositions, processes, and properties described herein. The examples are merely illustrative and are not intended to limit the disclosure to the materials, conditions, or process parameters set forth therein.

### EXAMPLES

### Material and Methods

### General Bacteria Assay:

Two whole carcasses were purchased from a local grocer on the day prior to testing. Carcasses were placed into an incubator at 37° C. for approximately 14 hours to ensure adequate bacterial growth. Whole carcasses were then rinsed using 400 mL of sterile buffered peptone water per carcass and bacterial rinses were combined in a single glass container. Bacterial rinsates were vacuum filtered through a ceramic Buchner funnel and a second time using a sterile syringe filter. The Vivione RAPID-B instrument start-up was performed using manufacturer's instructions (Vivione Biosciences, LLC, Pine Bluff, Ark.). Performance Verification was performed per manufacturer's instructions to verify performance and identify any potential problems. The Rapid-B system was then prepped for running General Bacteria Total Plate Count Assays. Treatment solutions were then prepared based on the protocol being tested. Solutions were inoculated 99:1; meaning 99 mL of treatment solution was combined with 1 mL of bacterial bird rinse, creating a 10⁻² dilution. Serial dilutions (10⁻³ dilution was commonly used) were performed using sterile buffered peptone water to amplify the dilution factor. Samples were prepared by combining 570 μl of sterile buffered peptone water, 330 μl of TPC (Total Plate Count) Reagent, and 100 μl from the dilution tube being tested into a reaction tube. This process dilutes the sample an additional 10⁻⁴ (Therefore, 10⁻⁴ was the general dilution tested). The sample reaction tube was left for 15 minutes, being periodically vortexed. The General Bacteria Protocol on the Vivione machine was opened and operational settings confirmed as instructed in the Vivione Biosciences manual. After 15 minutes, the reaction tube was placed on the sample arm and moved into the run position to begin analysis. Once the sample was running, the arm was returned to the flush position to allow for flushing upon completion.

Copper (II) sulfate pentahydrate and sodium hypochlorite were obtained commercially.

### Example 1

### Effect of Copper (II) in General Bacteria Assay

As the data demonstrates, copper (II) has negligible activity against bacteria at 5 ppm and 50 ppm concentrations. See Table 1. The amount of copper (II) salt is represented as ppm of copper. In solution phase, short exposure times (15 minutes or less) yield little, if any, antimicrobial effects with copper salt alone, especially at concentrations of 50 ppm or less (see Table 1).

TABLE 1

| Copper | pH* | Baseline | Average Live |
|---|---|---|---|
| 5 ppm | 5.68 | 1562 | 1633 |
| 50 ppm | 4.71 | 1562 | 1666 |

*pH at inoculation

### Example 2

### Effect of Hypochlorite in General Bacteria Assay

Hypochlorite has negligible antibacterial effect at about 5 ppm. See Table 2. The amount of hypochlorite is represented as ppm of chlorine.

TABLE 2

| chlorine | pH* | Baseline | Average Live |
|---|---|---|---|
| 5 ppm | 6.57 | 1562 | 1452 |
| 5 ppm | 7.13 | 408 | 405 |
| 10 ppm | 6.65 | 1562 | 859 |
| 10 ppm | 7.11 | 408 | 387 |
| 20 ppm | 7.02 | 408 | 90 |

*pH at inoculation

### Example 3

### Effect of Acid in General Bacteria Assay

pH alone can be effective at reducing bacterial load at very low pH. But it is only moderately effective at pH 2-3, which is considered a safe handling pH range. See Table 3. The amount of copper (II) salt is represented as ppm of copper. The amount of hypochlorite is represented as ppm of chlorine.

TABLE 3

| | | | Average |
|---|---|---|---|
| Sample | pH* | Baseline | Live |
| citric acid @ 0.25% | 2.43 | 408 | 75 |
| ascorbic acid @ 0.5% | 2.10 | 408 | 78 |
| citric acid @ 0.25% | | | |
| ascorbic acid @ 0.5% | 2.45 | 1562 | 255 |
| citric acid @ 0.25% | | | |
| 5 ppm chlorine | 2.55 | 1562 | 324 |
| ascorbic acid @ 0.5% | | | |
| citric acid @ 0.25% | | | |
| 5 ppm copper | 2.52 | 1562 | 201 |
| ascorbic acid @ 0.5% | | | |
| citric acid @ 0.25% | | | |

*pH at inoculation

### Example 4

### Effect of Copper (II)+Hypochlorite in General Bacteria Assay

Combinations of copper (II) salt (50 ppm or greater) and hypochlorite result in a synergistic reduction in bacterial load. This synergy is not simply a result of low pH.

TABLE 4

| | | | Average |
|---|---|---|---|
| Sample | pH* | Baseline | Live |
| 50 ppm copper + | 4.73 | 408 | 4 |
| 5 ppm chlorine | | | |
| 50 ppm copper + | 4.44 | 408 | 1 |
| 10 ppm chlorine | | | |
| 100 ppm copper + | 4.29 | 408 | 2.5 |
| 5 ppm chlorine | | | |
| 100 ppm copper + | 4.42 | 408 | 5 |
| 10 ppm chlorine | | | |
| 50 ppm copper + | 4.73 | 408 | 4 |
| 5 ppm chlorine | | | |
| 100 ppm copper + | 4.63 | 1562 | 4 |
| 5 ppm chlorine | | | |
| 5 ppm copper + | 5.79 | 1562 | 266 |
| 10 ppm chlorine | | | |
| 10 ppm copper + | 5.32 | 1562 | 127 |
| 5 ppm chlorine | | | |
| 5 ppm copper + | 2.49 | 1562 | 181 |
| 5 ppm chlorine + | | | |
| citric acid @ 0.25% + | | | |
| ascorbic acid @ 0.5% | | | |

*pH at inoculation

### Example 5

### Salmonella Assay

Salmonella cultures were exposed to liquid sanitization at predetermined pH values, chlorine concentrations and copper levels over a standard exposure time and then enumerated. The population of the challenge organisms prior to exposure was compared to the population present post-exposure to determine the germicidal ability of the sanitizer and parameter combination.

The following challenge microorganism was prepared for this study:
Salmonella enterica serovar Anatum (ATCC #9270)

Each culture was prepared from a lyophilized preparation (KWIK-STIK™, Microbiologics, St. Cloud, Minn.) according to manufacturer's instructions or from stock plates. The cultures were transferred into Tryptic Soy Broth (TSB, Neogen, Lansing, Mich.) and incubated at 35±2° C. for a minimum of 24±2 hours until the appearance of turbidity. After incubation, the cultures were centrifuged (Multifuge X1R, ThermoScientific, Waltham, Mass.), washed in sterile peptone water and resuspended to their original volume. The cultures were plated onto Tryptic Soy Agar (TSA, Neogen) at appropriate dilutions to determine the actual final concentration.

A 250 mL Erlenmeyer flask containing 99 mL of each pH modified and/or chlorine added sanitizer solution was prepared, along with an additional flask containing 99 mL of Butterfield's phosphate diluent (BPB) as a control. Sanitizer flasks were gently whirled to create residual liquid motion, and then a 1 mL aliquot of a test culture was added in the center of each flask, avoiding both the neck and sides of the flask during inoculation. Each flask was swirled for 1 minute to thoroughly mix the contents, and then a 1 mL portion of the mix was added to a 9 mL tube of a lecithin neutralizing solution (prepared as per AOAC 960.09)

After treatment and neutralization, samples were pour-plated at serial dilutions up to 10-6 (treating the neutralized tube as a 10-1) with Tryptone Glucose Extract Agar (TGEA, Neogen). TGEA plates were incubated at 36±1° C. for 24-30 hours. After incubation, plates were enumerated using a Quebec colony counter (Model #3325, Reichert Technologies, Depew, N.Y.). The numbers of observed colonies for the treated and untreated samples were recorded.

The raw count observed for each sample was converted to log10 cfu/mL. The amount of challenge organism present in the treated samples was compared to the amount present in the control samples to determine the log reduction for the challenge organism. This procedure was repeated in triplicate. The concentrations of Sodium Hypochlorite and Copper Sulfate Pentahydrate were calculated on a mass basis and confirmed with a Hach DR/890 Colorimeter utilizing the corresponding AccuVac® Ampules for Free Available Chlorine (FAC) and Copper.

### Example 6

### Effect of Acid in Salmonella Assay (Pathogenic Bacteria Example)

pH alone can be effective at reducing salmonella at low pH levels. At higher pH, minimal impact is observed. See Table 5. Control samples for these this example were prepared with Butterfield's Phosphate Diluent at a pH of 7.2. Base sanitizer consisting of sulfuric acid and ammonium sulfate were added to adjust pH accordingly. The raw count observed for each sample was converted to log10 cfu/mL. The amount of challenge organism present in the treated samples was compared to the amount present in the control samples to determine the log reduction for the challenge organism. Each condition was run in triplicate to create the stated value. See Example 5 for testing protocol.

TABLE 5*

| | | | Control | Treated |
|---|---|---|---|---|
| Chlorine | Copper | Solution | Sample | Sample |
| Concentration | Concentration | pH | Baseline | Reduction |
| 0 ppm | 0 ppm | 2.0 | 6.89 log | 4.03 log |
| 0 ppm | 0 ppm | 6.0 | 7.08 log | 0.61 log |

* n = 3

### Example 7

### Effect of Hypochlorite in Salmonella Assay (Pathogenic Bacteria Example)

Hypochlorite has limited antimicrobial effect at an optimized fixed chlorine pH operating level of 6.0 at lower ppm. See Table 6. The control sample was prepared with Butterfield phosphate diluent at a pH of 7.2. The desired concentrations of Sodium Hypochlorite and Copper Sulfate Pentahydrate were calculated on a mass basis and confirmed with a Hach DR/890 Colorimeter utilizing the corresponding AccuVac® Ampules for Free Available Chlorine (FAC) and Copper. The raw count observed for each sample was converted to log10 cfu/mL. The amount of challenge organism present in the treated samples was compared to the amount present in the control samples to determine the log reduction for the challenge organism. Each condition was run in triplicate to create the stated value. See Example 5 for testing protocol.

TABLE 6*

| | | | Control | Treated |
|---|---|---|---|---|
| Chlorine | Copper | Solution | Sample | Sample |
| Concentration | Concentration | pH | Baseline | Reduction |
| 15 ppm | 0 ppm | 6.0 | 6.75 log | 4.77 log |

*n = 3

### Example 8

### Effect of Copper (II)in Salmonella Assay (Pathogenic Bacteria Example)

Copper has limited antimicrobial effect at lower ppm (see Table 7). Longer dwell times of copper ion in solution result in greater bacterial reduction. The desired concentrations of Sodium Hypochlorite and Copper Sulfate Pentahydrate were calculated on a mass basis and confirmed with a Hach DR/890 Colorimeter utilizing the corresponding AccuVac® Ampules for Free Available Chlorine (FAC) and Copper. The raw count observed for each sample was converted to log10 cfu/mL. The amount of challenge organism present in the treated samples was compared to the amount present in the control samples to determine the log reduction for the challenge organism. Each condition was run in triplicate to create the stated value. See Example 5 for testing protocol.

TABLE 7*

| | | | Control | Treated |
|---|---|---|---|---|
| Chlorine | Copper | Solution | Sample | Sample |
| Concentration | Concentration | pH | Baseline | Reduction |
| 0 ppm | 10 ppm | 6.0 | 7.02 log | 3.83 log |

* n = 3

### Example 9

### Synergistic Effect of Lower Copper and Chlorine Concentrations at Higher pH

Combinations of copper (II) salt and hypochlorite result in a synergistic reduction in pathogenic bacteria load. See Table 8. This synergy is not simply a result of low pH or dwell time. Note the combination of copper and chlorine allows for significantly less dwell time in solution and a greater overall bacterial reduction (see results of Tables 4 and 8) at lower concentration levels. The amount of copper (II) salt is represented as ppm of copper. The amount of hypochlorite is represented as ppm of chlorine. The desired concentrations of Sodium Hypochlorite and Copper Sulfate Pentahydrate were calculated on a mass basis and confirmed with a Hach DR/890 Colorimeter utilizing the corresponding AccuVac® Ampules for Free Available Chlorine (FAC) and Copper. The amount of challenge organism present in the treated samples was compared to the amount present in the control samples to determine the log reduction for the challenge organism. Each condition was run in triplicate to create the stated value. See Example 5 for testing protocol.

As the data establishes, when formulated with acid and a buffering agent and chlorine, copper demonstrates significant bacterial reduction efficacy when bacteria is exposed to the solution at dwell times of 15 minutes or less.

TABLE 8*

| | | | Control | Treated |
|---|---|---|---|---|
| Chlorine | Copper | Solution | Sample | Sample |
| Concentration | Concentration | pH | Baseline | Reduction |
| 15 ppm | 10 ppm | 6.0 | 6.81 log | >5.81 log |

* n = 3

1. A composition comprising:
a hypochlorite salt;
a copper (II) salt; and
optionally an acid that is an inorganic acid, an organic acid, or a combination thereof;
wherein the composition has a chlorine concentration of 0.1 to 300 ppm and a copper (II) concentration of 0.1 to 300 ppm.

2. The composition of claim 1, wherein the chlorine concentration is between 0.1 and 75 ppm, between 0.1 and 50 ppm, between 0.1 and 25 ppm, between 0.1 and 10 ppm, about 4 ppm, or about 5 ppm.

3. (canceled)

4. (canceled)

5. (canceled)

6. (canceled)

7. The composition of claim 1, wherein the hypochlorite salt is sodium hypochlorite, calcium hypochlorite, magnesium hypochlorite, or a combination thereof.

8. (canceled)

9. The composition of claim 1, wherein the copper (II) concentration is between 0.1 and 150 ppm, between 0.1 and 125 ppm, between 0.1 and 100 ppm, between 0.1 and 50 ppm, between 0.1 and 25 ppm, between 0.1 and 10 ppm, or between 0.1 and 5 ppm.

10. (canceled)

11. (canceled)

12. (canceled)

13. (canceled)

14. (canceled)

15. (canceled)

16. The composition of claim 1, wherein the copper (II) salt is copper (II) sulfate.

17. The composition of claim 1, wherein the composition comprises the acid and the acid is sulfuric acid, lactic acid, citric acid, or a combination thereof.

18. The composition of claim 1, consisting essentially of the hypochlorite salt, the copper (II) salt, and the acid and having a chlorine concentration of 0.1 to 300 ppm and a copper (II) concentration of 0.1 to 300 ppm or consisting essentially of the hypochlorite salt and the copper (II) salt, and having a chlorine concentration of 0.1 to 300 ppm and a copper (II) concentration of 0.1 to 300 ppm.

19. (canceled)

20. The composition of claim 18, further comprising water.

21. The composition of claim 1, wherein the composition is an aqueous solution.

22. The composition of claim 21, wherein the pH of the aqueous solution is less than 7, at 25° C., is between 1 and 7, at 25° C., is between 2 and 7, at 25° C., is between 3 and 7, at 25° C., or is between 4 and 7, at 25° C.

23. (canceled)

24. (canceled)

25. (canceled)

26. (canceled)

27. The composition of claim 1, further comprising a buffering agent.

28. (canceled)

29. The composition of claim 1, wherein the composition is in the form of a solid that is a pellet, granule, powder, or tablet wherein the solid is optionally encased in a water soluble film.

30. (canceled)

31. A method comprising
applying the composition of claim 1 to a surface.

32. The method of claim 31, wherein the surface is a foodstuff surface wherein the foodstuff is a meat product, a produce product, or a dairy product.

33. (canceled)

34. (canceled)

35. (canceled)

36. (canceled)

37. (canceled)

38. (canceled)

39. The method of claim 31, wherein the microbe is a bacterium and the bacterium is salmonella enteritidis, listeria monocytogenes, Escherichia coli, clostridium botulinum, campylobacter, or a combination thereof; or wherein the microbe is a virus and the virus is a meat product, a produce product, or a dairy product.

40. (canceled)

41. (canceled)

42. A method comprising
adding a copper (II) salt; and optionally an acid that is an inorganic acid, an organic acid, or a combination thereof to a first aqueous solution comprising a hypochlorite salt;
to produce a second aqueous solution comprising the hypochlorite salt, the copper (II) salt, and optionally the acid, the second aqueous solution having a pH below 7 at 25° C., a chlorine concentration of 0.1 to 300 ppm, and a copper (II) concentration of 0.1 to 300 ppm; and
the second aqueous solution contacting a surface.

43. The method of claim 42, wherein the hypochlorite salt is sodium hypochlorite, calcium hypochlorite, magnesium hypochlorite, or a combination thereof.

44. (canceled)

45. The method of claim 42, wherein the chlorine concentration is between 0.1 and 75 ppm, is between 0.1 and 50 ppm, is between 0.1 and 25 ppm, is between 0.1 and 10 ppm, or is between 0.1 and 4 ppm.

46. (canceled)

47. (canceled)

48. (canceled)

49. (canceled)

50. The method of claim 42, wherein the copper (II) salt is copper (II) sulfate.

51. The method of claim 42, wherein the copper (II) concentration is between 0.1 ppm and 150 ppm, is between 0.1 ppm and 125 ppm, is between 0.1 ppm and 100 ppm, is between 0.1 ppm and 50 ppm, is between 0.1 ppm and 25 ppm, is between 0.1 ppm and 10 ppm, or is between 0.1 ppm and 5 ppm.

52. (canceled)

53. (canceled)

54. (canceled)

55. (canceled)

56. (canceled)

57. (canceled)

58. The method of claim 42, wherein the acid is added to the first aqueous solution and the acid is sulfuric acid, lactic acid, or a combination thereof.

59. The method of claim 42, wherein the first aqueous solution further comprises a buffering agent.

60. (canceled)

61. The method of claim 42, wherein the copper (II) salt and optionally the acid are provided as a third aqueous solution comprising the copper (II) salt and optionally the acid.

62. The method of claim 42, wherein the pH of the second aqueous solution is less than 7, at 25° C.

63. The method of claim 42, wherein the surface is a foodstuff surface and wherein the foodstuff is a meat product, a produce product, or a dairy product.

64. (canceled)

65. (canceled)

66. (canceled)

67. (canceled)

68. (canceled)

69. The method of claim 42, wherein the surface is a hard surface.

70. The method of claim 42, wherein the microbe is a bacterium and the bacterium is salmonella enteritidis, listeria monocytogenes, Escherichia coli, clostridium botulinum, campylobacter, or a combination thereof; or wherein the microbe is a virus and the virus is enterovirus, norovirus, or rotavirus.

71. (canceled)

72. (canceled)

73. (canceled)
